(19) United States
(12) Patent Application Publication
(10) Pub. No.: US 2026/0217513 A1
(43) Pub. Date: Jul. 30, 2026

(54) PLATFORM LIFT SYSTEMS FOR ROBOTIC VEHICLES AND RELATED METHODS

(71) Applicant: Ocado Innovation Limited, Hatfield (GB)

(72) Inventors: Callum Gow, Cambridge, MA (US); Michael Caine, Needham, MA (US); Kurt Bilis, Medford, MA (US); Christopher Cacioppo, Somerville, MA (US); Knight Ko, Quincy, MA (US)

(21) Appl. No.: 19/401,088

(22) Filed: Nov. 25, 2025

Related U.S. Application Data
(63) Continuation of application No. PCT/EP2024/064402, filed on May 24, 2024.
(60) Provisional application No. 63/504,252, filed on May 25, 2023.

(30) Foreign Application Priority Data
Nov. 3, 2023 (GB) 2316875.0

(51) Int. Cl. B66F 9/10; B66F 9/06; B66F 9/24

(52) U.S. Cl. CPC B66F 9/10; B66F 9/063; B66F 9/24

(57) ABSTRACT

Platform lift systems for robotic vehicles and related methods are disclosed. An example robotic vehicle includes a body defining a platform support area; a lift shuttle moveable relative to the body, the lift shuttle including a first fork and a second fork; machine-readable instructions; and processor circuitry to execute the machine-readable instructions to cause the lift shuttle to move from a first position to a second position relative to the body to cause the first fork and the second fork to protrude relative to the body; cause the first fork and the second fork to lift a platform; and cause the body of the vehicle to move toward the platform when the first fork and the second fork are protruded to position the platform support area under the platform.

### RELATED APPLICATIONS

This is a continuation of International Application No. PCT/EP2024/064402, which is entitled “Platform Lift Systems for Robotic Vehicles and Related Methods” and which was filed on May 24, 2024. International Application No. PCT/EP2024/064402 claims priority to U.S. Provisional Patent Application No. 63/504,252, filed on May 25, 2023, and to Great Britain Patent Application No. 2316875.0, filed on Nov. 3, 2023. International Application No. PCT/EP2024/064402, U.S. Provisional Patent Application No. 63/504,252, and Great Britain Patent Application No. 2316875.0 are hereby incorporated herein by reference in their entireties. Priority to International Application No. PCT/EP2024/064402, U.S. Provisional Patent Application No. 63/504,252, and Great Britain Patent Application No. 2316875.0 is hereby claimed.

### FIELD OF THE DISCLOSURE

This disclosure relates generally to robotic vehicles and, more particularly, to platform lift systems for robotic vehicles and related methods.

### BACKGROUND

A robotic vehicle (e.g., a robotic truck) can include forks (also referred to as tynes or tines) to enable the vehicle to pick up and move object(s) (e.g., a pallet) in an environment such as a warehouse.

A platform such as a pallet may be used in a warehouse to support goods and to enable the goods to be carried from one location to another while on the platform. The platform includes opening(s) or slot(s) to facilitate lifting of the platform by a vehicle such as a forklift truck. Platforms can vary in size, shape, weight, form factor, etc.

To lift heavily loaded pallets, some vehicles (e.g., forklift trucks) have a cantilever design in that the vehicle includes a large mass to serve as a counterweight when the forks are extended and lifting the platform. However, such a design may not be efficient for robotic vehicles operating in a warehouse, as the increased mass of the vehicle can raise safety concerns, increase costs, and lower operational energy efficiency of the vehicles.

Some platform-lifting vehicles include forks that are spaced apart such that when the forks engage the platform to lift the platform, the legs or wheels of the vehicle are located alongside the platform. The wide stance of the legs can stabilize the vehicle during lifting of the platform (e.g., by moving the lift point forward across the platform). However, such a design increases the width of a frame of the vehicle, which can affect movement of the vehicle within a warehouse, which may have narrow and/or crowded aisles. Such a design also hinders lifting or placing platforms close to each other in the (e.g., tightly spaced) warehouse. Also, the wide stance design may prevent docking with certain pallet designs.

Some manually operated vehicles (e.g., pallet jacks) include forks with wheels to raise the platform. However, when entering the openings of the platform, the wheels of the forks roll over any stringers that form a bottom portion of the platform. Rolling the wheels over the stringers can damage the platform and require extra force by the user to push the vehicle.

According to a first aspect of the present disclosure there is provided a robotic vehicle comprising: a body, the body comprising a platform support area; a drive means configured, in use, to move the robotic vehicle on a surface, the drive means comprising one or more rotatable means to support the robotic vehicle on a surface; a lifting shuttle comprising an actuator, a first fork and a second fork; the first fork comprising a first lifting leg received near a first end of the first fork and a second lifting leg received near a second end of the first fork; the second fork comprising a first lifting leg received near a first end of the second fork and a second lifting leg received near a second end of the second fork; the first and second forks being received within the body such that the first and second forks are held above the surface; the actuator being coupled to the lifting legs; wherein in use the robotic vehicle is configured to; extend the second end of the first and second forks to protrude from the body of the robotic vehicle; insert at least a portion of the first and second forks into the interior of a platform; activate the actuator to cause the first and second lifting legs of the first and second forks to extend to contact the surface and lift the platform; move relative to the platform such that the platform is received above the platform support area; and retract the first and second lifting legs of the first and second forks such that the platform is received on the platform support area.

The robotic vehicle of the present disclosure enables a platform, such as a pallet, to be lifted with a significantly reduced risk of damaging the platform, especially if the platform comprises stringers. The insertion of the forks above the level of the surface avoids contact with any stringers. Furthermore, the forks can be inserted such that the lifting legs can be extended to contact the surface, avoiding contact with any stringers.

The use of the two lifting legs in each of the two forks and the spacing apart of the lifting legs along the length of each fork provides a stable and efficient lifting platform. The connection of the two lifting legs equalizes the lifting forces on each lifting leg.

The actuator may be directly connected to the first lifting legs of the first fork and the second fork. In alternative example, the robotic vehicle may comprise a first actuator and a second actuator, the first actuator being directly connected to the first lifting leg of the first fork and the second actuator being directly connected to the first lifting leg of the second fork. Each of the first lifting legs may be connected to the respective second lifting leg by a connector received within the respective fork.

The first and second lifting legs may be received in a retracted position within their respective fork. The actuation of the actuator may cause the first and second lifting legs to rotate from their retracted position such that they contact the surface and lift the platform.

The lifting shuttle may further comprise an actuator support. The first end of the first fork and the first end of the second fork may be supported by the actuator support. The movement of the lifting shuttle may cause the second end of the first and second forks to protrude from the body of the robotic vehicle. The lifting shuttle may move from a first position within the body of the robotic vehicle to a second position which is partially or entirely outside of the body of the robotic vehicle.

According to a second aspect of the present disclosure there is provided a method of lifting a platform from a surface using a robotic vehicle the method comprising: advancing a first fork and a second fork from the robotic vehicle into the interior of the platform, the first fork comprising a first lifting leg and second lifting leg and the second fork comprising a first lifting leg and a second lifting leg, wherein the robotic vehicle supports the first fork and the second fork above the surface; applying a force to the first lifting leg and the second lifting leg of the first and second forks such that the first lifting leg and the second lifting leg of the first and second forks contact the surface; applying a force to the first lifting leg and the second lifting leg of the first and second forks such that the platform is lifted from the surface; moving the platform so it is received above a support area of the robotic vehicle; and moving the platform so it is received on the support area of the robotic vehicle.

The platform may be moved such that it is received on the support area of the robotic vehicle by advancing the robotic vehicle towards the platform and lowering the platform onto the support area of the robotic vehicle. The platform may be lowered onto the support area of the robotic vehicle by reducing the force that is applied to the first lifting leg and the second lifting leg of the first and second forks.

According to a further aspect of the present disclosure there is provided a non-transitory computer-readable medium comprising instructions executable by processing circuitry of a robotic vehicle whereby the processing circuitry is configured to perform a method as set out above.

### BRIEF DESCRIPTION OF THE DRAWINGS

FIGS. 1A-10 illustrate an example robotic vehicle including a lifting shuttle to lift a platform and lifting control circuitry to control the lifting shuttle in accordance with teachings of this disclosure;

FIGS. 1A-1B illustrate an example robotic vehicle in accordance with teachings of this disclosure, with FIG. 1A showing a schematic representation of the robotic vehicle and FIG. 1B showing a depiction of some aspects of the robotic vehicle that are not shown in FIG. 1A;

FIG. 2 illustrates the forks of the lifting shuttle extended into the opening(s) of the platform;

FIG. 3 shows the example robotic vehicle configured such that the forks are received above the level of the surface (e.g., floor) on which the platform rests;

FIG. 4 shows the lifting legs extended and engaged with the underlying surface;

FIG. 5 shows the robotic vehicle positions itself in a position next to the platform such that the forks of the robotic vehicle are aligned with the openings of platform;

FIG. 6 shows the lifting shuttle having been advanced from the body of the robotic vehicle such that the first and second forks have inserted into the interior of the platform;

FIG. 7 shows the robotic vehicle in the process of lifting the platform;

FIG. 8 shows the robotic vehicle having lifted the platform to a level that is above the level of the platform support area such that the body of the robotic vehicle can move forward such that the movement of the vehicle positions a region of the platform support area underneath the platform;

FIG. 9 shows the continuation of this movement such that the lifting shuttle is received within the body of the robotic vehicle as the vehicle moves to position the platform support area under the platform;

FIG. 10 illustrates the platform loaded onto the platform support area;

FIGS. 11-13 illustrate an example lifting system of the lifting shuttle of FIGS. 1A-10;

FIG. 14 is a block diagram of an example implementation of the lifting control circuitry of FIGS. 1A-1B;

FIG. 15 is a flowchart representative of example machine readable instructions and/or example operations that may be executed, instantiated, and/or performed by example programmable circuitry to implement the lifting control circuitry of FIG. 14; and

FIG. 16 is a block diagram of an example processing platform including programmable circuitry structured to execute, instantiate, and/or perform the example machine readable instructions and/or perform the example operations of FIG. 15 to implement the lifting control circuitry of FIG. 14.

In general, the same reference numbers will be used throughout the drawing(s) and accompanying written description to refer to the same or like parts. The figures are not necessarily to scale.

### DETAILED DESCRIPTION

Disclosed herein are examples of robotic vehicles (e.g., autonomous vehicles, robotic trucks, robotic pallet jacks, etc.) having forks to support and/or carry object(s), such as a platform including goods (e.g., a pallet with goods placed thereon). Example robotic vehicles disclosed herein include a retractable fork system to lift the platform and a support area on which the lifted platform can be placed to enable the vehicle to carry the platform. Example retractable fork systems disclosed herein include forks that extend from a body of the vehicle and are suspended in the air when entering the opening(s) or slot(s) of the platform. The forks include lifting legs that move from a retracted position to an extended position when the forks are in a position to lift the platform. In the extended position, the lifting legs contact a ground surface (e.g., a floor) and, as a result, raise, push, or move the platform upward via the forks. Once lifted, the vehicle moves toward the platform such that the support area is positioned below the lifted platform and the forks are located within the support area (e.g., no longer protruding from the vehicle body). When the support area is under the platform, the lifting legs retract and the pallet is lowered onto the support area.

The suspension of the forks when docking with the platform enables the forks to be used with different types of platforms (e.g., pallets with or without stringers at the bottom of the pallet). Further, the selective deployment of the lifting legs after positioning the forks relative to the platform reduces instances of damage to the legs and/or the platform as compared to if the legs were driven over the bottom surface of the platform.

Example robotic vehicles disclosed herein include sensors to generate outputs indicative of, for examples, a position of the vehicle body relative to the platform, a position of the forks relative to the platform when the forks are inserted into the opening(s) of the platform, a weight of the platform, etc. The sensors can include image sensor(s), proximity sensor(s), weight sensor(s), etc. Examples disclosed herein include lifting control circuitry to analyze the outputs of the sensor(s) and to control movement of the vehicle body, the forks, and the lifting legs based on the sensor output(s) to lift and place the platform on the vehicle.

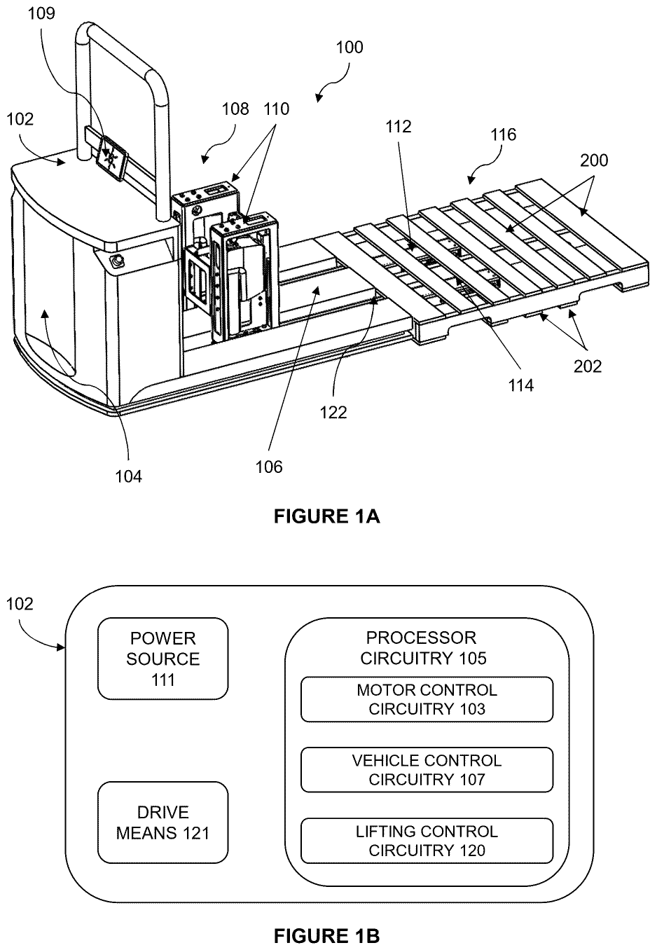

FIGS. 1A-1B illustrate an example robotic vehicle 100 in accordance with teachings of this disclosure, with FIG. 1A showing a schematic representation of the robotic vehicle and FIG. 1B showing a depiction of some aspects of the robotic vehicle that are not shown in FIG. 1A. The example robotic vehicle 100 comprises a body 102 and a drive means 121 which may comprise one or more motors (e.g., electric motor(s) and/or other drive mechanism(s)) to cause movement of the body 102 via the wheel(s) of the robotic vehicle 100. The robotic vehicle 100 includes motor control circuitry 103 (e.g., hardware and/or software components) to control, for example, a speed of the robotic vehicle 100. One or more components of the motor control circuitry 103 can be implemented by processor circuitry 105 of the vehicle 100.

The robotic vehicle 100 can include an autonomous vehicle. The robotic vehicle 100 includes vehicle control circuitry 107 to control movement of the autonomous or self-driving robotic vehicle 100. One or more components of vehicle control circuitry 107 can be implemented by the processor circuitry 105 of the robotic vehicle 100, processor circuitry of another user device, and/or cloud-based device(s). The robotic vehicle 100 moves to a location in an environment (e.g., a warehouse) without or with limited user input control during movement of the vehicle 100.

In some examples, the robotic vehicle 100 includes a display screen 109 to present data to user(s) of the robotic vehicle 100. In some examples, the robotic vehicle 100 includes speaker(s) to provide audio output(s) to user(s) interacting with the robotic vehicle 102. The example robotic vehicle 100 of FIGS. 1A-1B includes a power source 111 such as a battery to provide power to the components of the robotic vehicle 100.

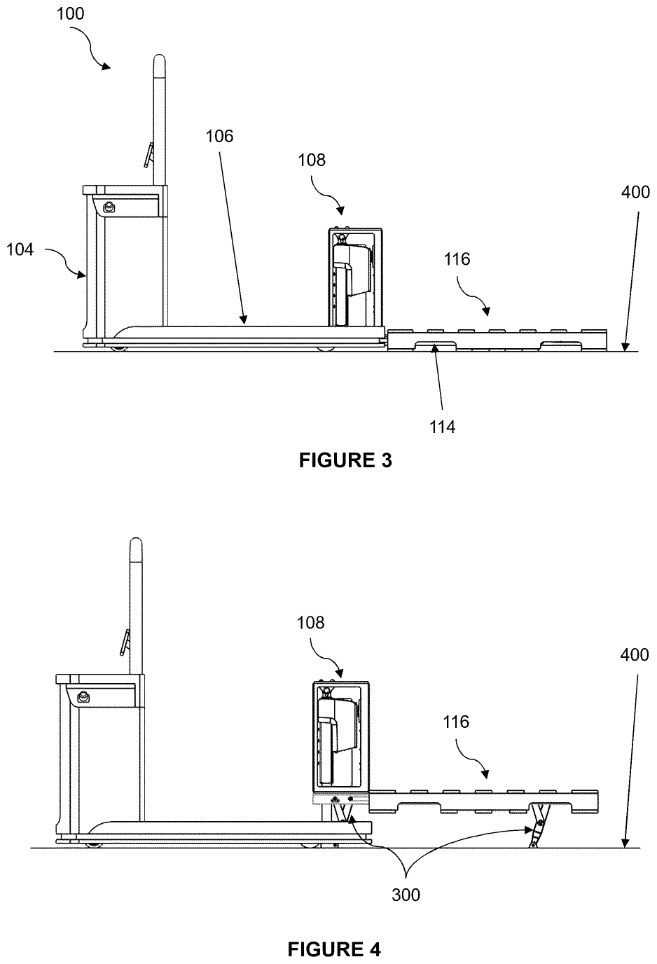

In the example of FIGS. 1A-1B, the body 102 of the robotic vehicle 100 defines a housing 104 and a platform support area 106. The example robotic vehicle 100 includes a lifting shuttle 108 that is moveable relative to the platform support area 106 from a first or stored position to a second or protruded position. The lifting shuttle 108 includes an actuator support 110, a first fork 112, and a second fork 114. The platform support area 106 can define openings defined by sidewalls of the body 102 that include tracks or rails to receive the forks 112, 114 and facilitate movement of the lifting shuttle 108. The platform support area 106 can include, for example, a rack and pinion or chains to drive movement of the lifting shuttle 108 (e.g., the push or pull the forks 112, 114 relative to the platform support area 106). As disclosed herein, the actuator support 110 supports actuator(s) (FIG. 8), which cause lifting legs (FIG. 3) of the forks 112, 114 to deploy to lift a platform 116 (e.g., a pallet). The actuator support 110 can also serve as a counterweight to facilitate stability of the vehicle 100 when the forks 112, 114 are extended relative to the vehicle body 102. The actuator support 110 can be disposed in the housing 104 of the vehicle 100 when not in use and/or when the platform 116 is carried by the platform support area 106.

In the example of FIGS. 1A-1B, the platform support area 106 includes sensor(s) 118 to detect when the vehicle 100 is proximate to the platform 116. In some examples, the lifting shuttle 108 additionally or alternatively includes the sensor(s) 118 (e.g., located on the actuator support 110, on the fork(s) 112, 114). The sensor(s) 118 can include, for example, image sensor(s), proximity sensor(s), infrared sensor(s), LIDAR sensor(s), etc.

In the example of FIGS. 1A-1B, the outputs of the sensor(s) 118 are analyzed by lifting control circuitry 120. One or more components of lifting control circuitry 120 can be implemented by the processor circuitry 105 of the robotic vehicle 100, processor circuitry of another user device, and/or cloud-based device(s). Based on the outputs of the sensor(s) 118, the lifting control circuitry 120 detects when the vehicle 100 is proximate to the platform 116. In particular, the lifting control circuitry 120 detects when the body 102 of the vehicle 100 is aligned with the platform 116 such that when the forks 112, 114 extend relative to the body 102, the forks 112, 114 enter slot(s) or opening(s) 122 of the platform 116.

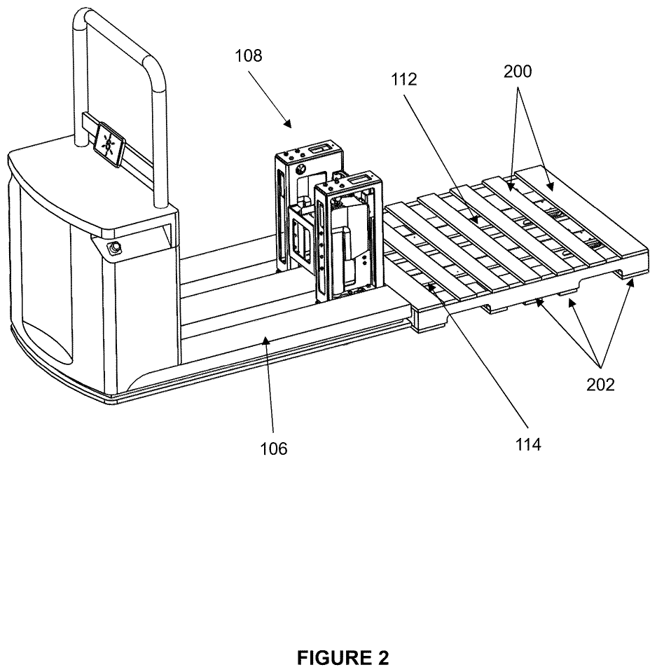

FIG. 2 illustrates the forks 112, 114 of the lifting shuttle 108 extended into the opening(s) 122 of the platform 116. In the example of FIGS. 1A-1B, when the lifting control circuitry 120 detects that the body 102 of the vehicle 100 is aligned with the platform 116 to dock with the platform 116, the lifting control circuitry 120 generates instructions to cause the lifting shuttle 108 to move toward the platform 116. The lifting shuttle 108 (e.g., the forks 112, 114, the actuator support 110) can move toward the platform 116 via actuator(s) (not shown) associated with the platform support area that drive the lifting shuttle 108 along rails or tracks defined in the platform support area 106 (e.g., a rack and pinion, a chain). As a result of movement of the lifting shuttle 108, the forks 112, 114 protrude from the body 102 and enter the opening(s) 122. When the forks 112, 114 are disposed in the opening(s) 122 of the platform 116 as shown in FIG. 2, a first end of the respective forks 112, 114 is supported by the actuator support 110. A remaining portion of the respective forks 112, 114 is suspended within the opening(s) 122 of the platform 116. Put another way, the forks 112, 114 are suspended above a surface (e.g., a floor) on which the platform 116 rests between an upper surface 200 of the platform 116 and stringer(s) 202 defining a bottom portion of the platform 116.

FIGS. 3 and 4 are side views of the example robotic vehicle 100 when the forks 112, 114 of the lifting shuttle 108 are disposed in the opening(s) 122 of the platform 116. The forks 112, 114 include lifting legs 300. Each of the forks 112, 114 can include two lifting legs 300 (e.g., a first lifting leg disposed proximate to a first end of the respective forks 112, 114 and a second leg disposed proximate to a second end of the respective forks 112, 114).

As shown in FIG. 3, the example robotic vehicle is configured such that the forks are received above the level of the surface 400 (e.g., floor) on which the platform 116 rests. Thus, the forks can be inserted into the platform without colliding with or damaging the stringers 202 of the platform. An aspect of one or the forks 114 cam be seen received within the interior of the platform. At this stage, that is prior to the activation of the actuator, the lifting legs 300 are in a retracted position such that they are received inside the first or second fork respectively. The lifting control circuitry 120 analyzes output(s) of the sensor(s) 118 to detect that the forks 112, 114 are positioned relative to the platform 116 such that the lifting legs 300 can be extended and will engage with the surface 400. Put another way, the lifting control circuitry 120 determines that when deployed, the lifting legs 300 will contact the surface 400 and not contact the stringer(s) 202 of the platform 116, which could damage the platform 116. When the lifting control circuitry 120 determines that the forks 112, 114 are in position relative to the platform 116, the lifting control circuitry 120 generates instructions to cause actuator(s) of the lifting shuttle 108 to cause the lifting legs 300 to extend and engage (e.g., contact, rest on, push on) the surface 400, as shown in FIG. 4.

The extension of the lifting legs 300 causes the platform 116 to be lifted from the surface 400 (e.g., the lifting legs 300 push the platform 116 and the forks 112, 114 upward as a result of extension and contact with the surface 400). In particular, the extension of the lifting legs 300 causes the platform 116 to be raised and supported by the forks 112, 114 (e.g., the forks 112, 114 are greater distance from the floor 400 when the legs 300 are extended in FIG. 4 as compared to the position of the forks in FIG. 3). In some examples, the sensor(s) 118 include weight sensor(s) and the lifting control circuitry 120 determines the mass or weight of the platform 116 including any load thereon. In some examples, if the lifting control circuitry 120 determines that the weight of the platform 116 exceeds a threshold, the lifting control circuitry 120 instructs the lifting legs 300 to retract to lower the platform 116 and causes the forks 112, 114 to disengage from the platform 116 for safety purposes.

The lifting control circuitry 120 determines, based on the output(s) of the sensor(s) 118, when the platform 116 has been raised to a sufficient height such that the bottom surface (e.g., the stringer(s) 202) of the platform 116 is higher than or above the platform support area 106. When the lifting control circuitry 120 determines that the platform 116 satisfies a clearance threshold relative to the platform support area 106, the lifting control circuitry 120 instructs the robotic vehicle 100 to move toward the platform 116 such that the platform support area 106 is positioned underneath the platform 116. In this example, the lifting shuttle 108 remains stationary as a result of the engagement of the legs 300 with the surface 400 and the vehicle 100 moves the vehicle body 102 (e.g., the platform support area 106) toward the protruded lifting shuttle 108 and the platform 116.

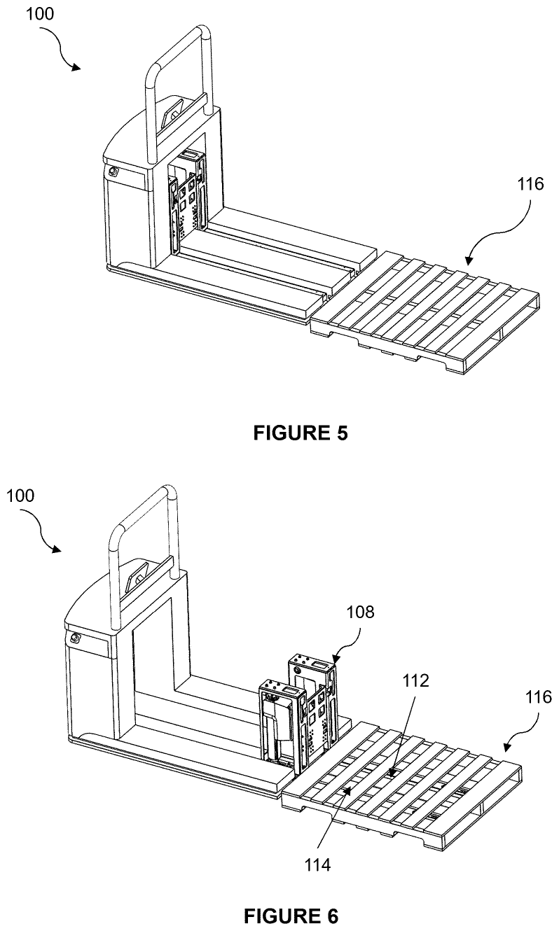

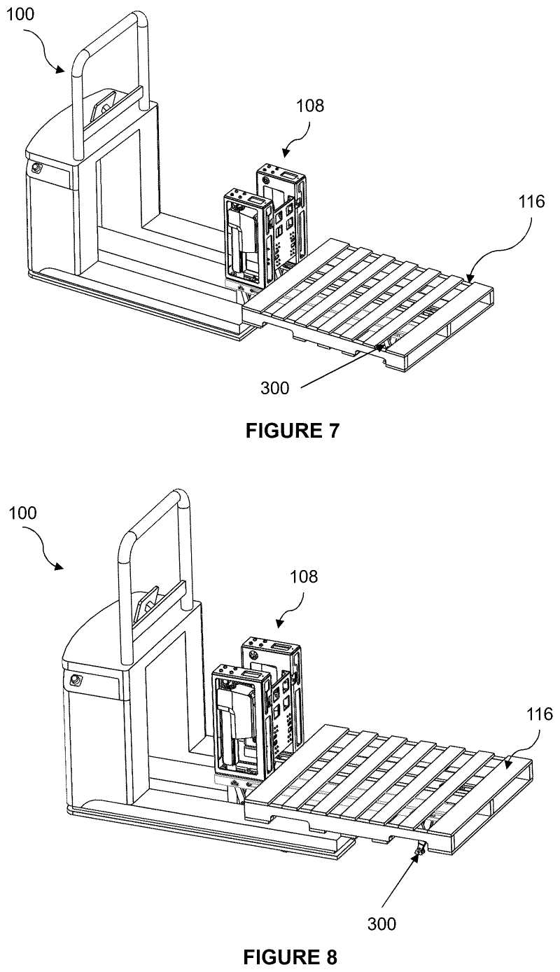

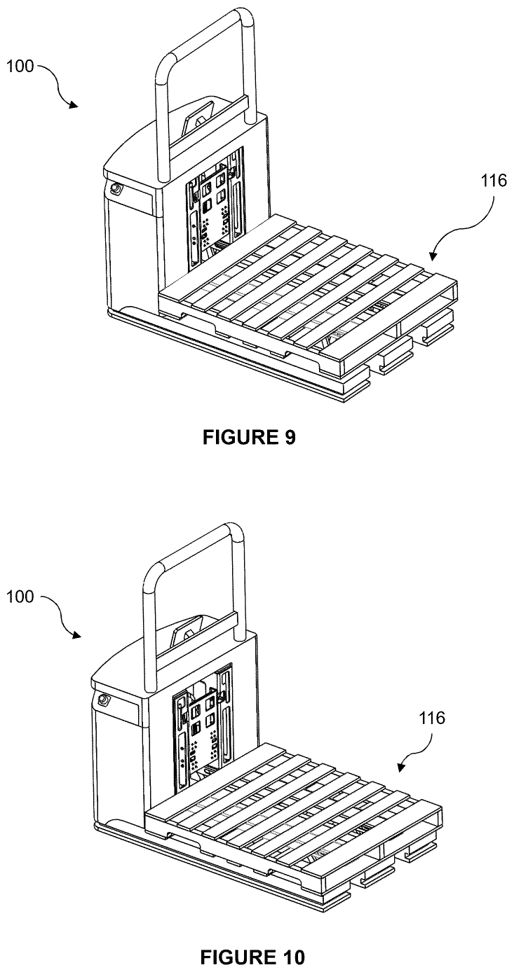

FIGS. 5 to 10 show schematic depictions illustrating the movement of the vehicle when a platform 116 is lifted by the forks 112 114 and then received on th4 platform support area 106 of the robotic vehicle. As shown in FIG. 5, the robotic vehicle positions itself in a position next to the platform such that the forks of the robotic vehicle are aligned with the openings of platform. FIG. 6 shows the lifting shuttle 108 having been advanced from the body of the robotic vehicle such that the first and second forks 112 114 have inserted into the interior of the platform 116. FIG. 7 shows the robotic vehicle in the process of lifting the platform 116. The lifting legs 300 have been deployed and are pressing against the floor, causing the platform to be lifted from the floor. FIG. 8 shows the robotic vehicle having lifted the platform to a level that is above the level of the platform support area 106 such that the body of the robotic vehicle can move forward such that the movement of the vehicle 100 positions a region of the platform support area 106 underneath the platform 116. FIG. 9 shows the continuation of this movement such that the lifting shuttle is received within the body of the robotic vehicle (e.g., enters the housing 104 via an opening to a cavity of the housing) as the vehicle 100 moves to position the platform support area 106 under the platform 116.

FIG. 10 illustrates the platform 116 loaded onto the platform support area 106. The lifting control circuitry 120 determines, based on the outputs of the sensor(s) 118, when the platform support area 106 is in a loading position relative to the platform 116 such that the platform 116 can be placed on and supported by the platform support area 106. When the lifting control circuitry 120 determines that the platform support area 106 is in the loading position, the lifting control circuitry 120 instructs the lifting legs 300 to retract, thereby causing the forks 112, 114 to lower and the platform 116 to be supported by (e.g., at least partially rest on) the platform support area 106 as shown in FIG. 7. In some examples (e.g., when the platform 116 includes the stringers 202 extending across the bottom of the platform 116), the forks 112, 114 remained engaged or docked with the platform 116 (e.g., disposed in the platform opening(s) 122) when the platform 116 is in the loaded position on the platform support area 106.

Although FIGS. 1-10 illustrate loading of the platform 116 onto the robotic vehicle 100, the lifting shuttle 108 can be used to offload the platform 116 from the vehicle 100. In such examples, the lifting control circuitry 120 causes the lifting legs 300 to extend while the platform 116 is supported by the platform support area 106. The extension of the lifting legs 300 causes the forks 112, 114 to lift the platform 116 off of the platform support area 106. When the forks 112, 114 and the platform 116 are lifted, the lifting control circuitry 120 causes the vehicle 100 to move away from the platform 116 to pull the platform support area 106 out from underneath the platform 116. When the platform support area 106 has cleared the platform 116, the lifting control circuitry 120 causes the lifting legs 300 to retract, thereby lowering the forks 112, 114 and causing the platform 116 to rest on the surface 400 (e.g., the floor). The lifting control circuitry 120 causes the forks 112, 114 to retract from the opening(s) 122 of the platform 116 (e.g., by causing the lifting shuttle 108 to move toward the housing 104 of the vehicle 100).

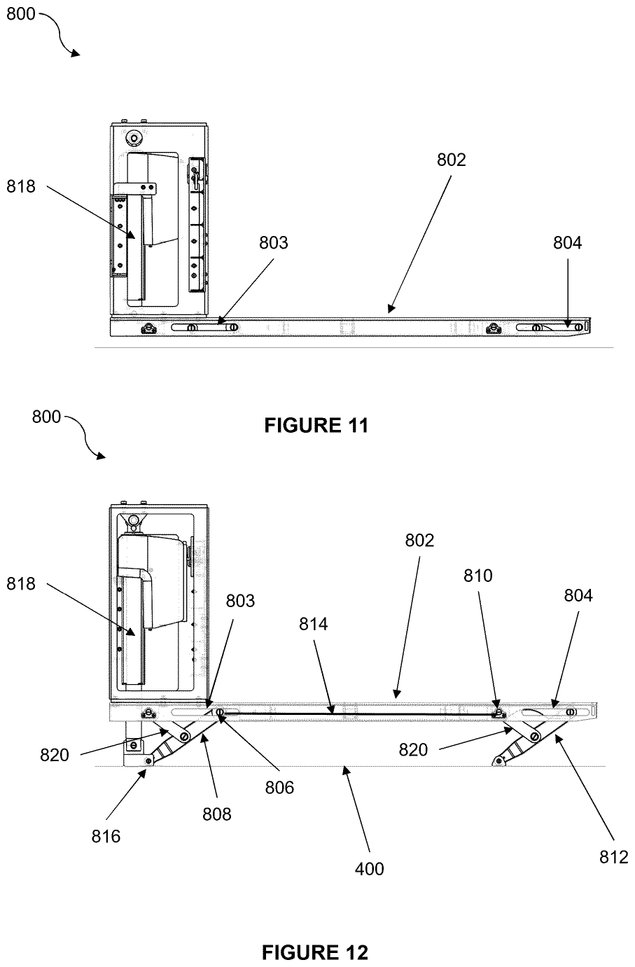

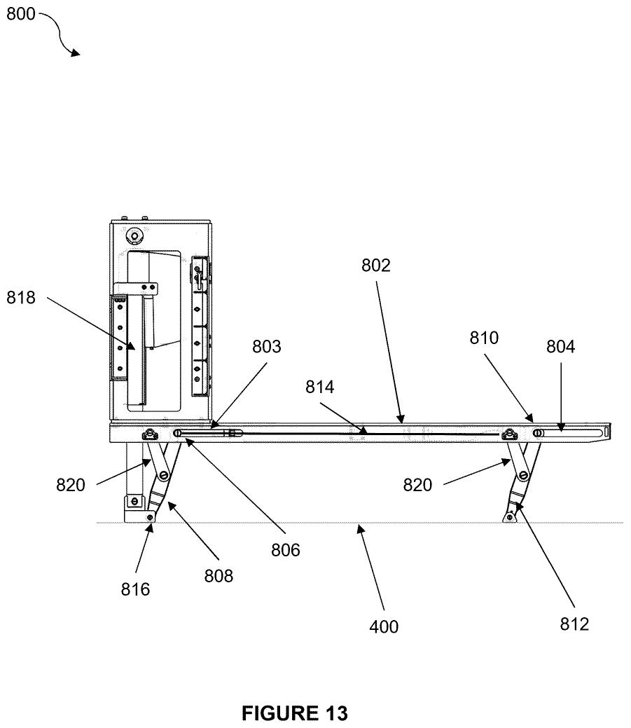

FIGS. 11-13 illustrate an example lifting system 800 of the lifting shuttle 108 of the example robotic vehicle 100. A fork 802 (e.g., the fork 112, 114 of FIGS. 1-10) includes a first channel 803 and a second channel 804. A first end 806 of a first lifting leg 808 (e.g., one of the lifting legs 300 of the respective forks 112, 114) is disposed in the first channel 803 and a first end 810 of a second lifting leg 812 (e.g., the other one of the lifting legs 300 of the respective forks 112, 114) is disposed in the second channel 804. The first end 806 of the first lifting leg 808 is coupled to the first end 810 of the second lifting leg 812 via a connector 814 carried by the fork 802. A second end 816 of the first lifting leg 808 is coupled to an actuator 818. The actuator 818 can include, for example, an electronic cylinder (e.g., a linear actuator). In some examples, the actuator 818 is a hydraulic-based actuator or a pneumatic actuator. The actuator 818 can be supported by the actuator support 110 of FIGS. 1-10. Although in the example of FIG. 11 each of the lifting systems 800 associated with the respective forks 802 (e.g., the forks 112, 114) includes one actuator 818, in other examples, the robotic vehicle may comprise two actuators. In such an example a first actuator may be used to control the movement of the two lifting legs 300 of the first fork 112 and a second actuator may be used to control the two lifting legs 300 of the second fork 114.

As shown in FIGS. 11-13, activation of the actuator 818 causes the first lifting leg 808 to move from a retracted position to an extended position via movement of second end 816 of the first lifting leg 808, which pulls the first end 806 of the first lifting leg 808 along the first channel 803. As the first lifting leg 808 extends, the movement of the first end 806 of the first lifting leg 808 pulls the first end 810 of the second lifting leg 812 along the second channel 804 via the connector 814, which causes the second lifting leg 812 to extend. The example lifting system 800 includes linkages 820 to support and/or facilitate movement of the lifting legs 808, 812 relative to the fork 802. Thus, the example lifting system 800 transfers force horizontally via the channels 803, 804 and along the fork 802. As a result, each of the lifting legs 808, 812 provide equal or substantially equal lifting force to raise the fork 802 and the platform 116. Further, the legs 808, 812 and the linkages 820 are sized such that when the legs 808, 812 are retracted, the fork 802 (including the legs 808, 812 and the linkages 820) fits through the opening(s) 122 of the pallet 116 without interference.

Although examples disclosed herein are discussed in connection with loading and unloading pallets, the example lifting systems disclosed herein can be used for other purposes such as raising a vehicle chassis for maintenance purposes.

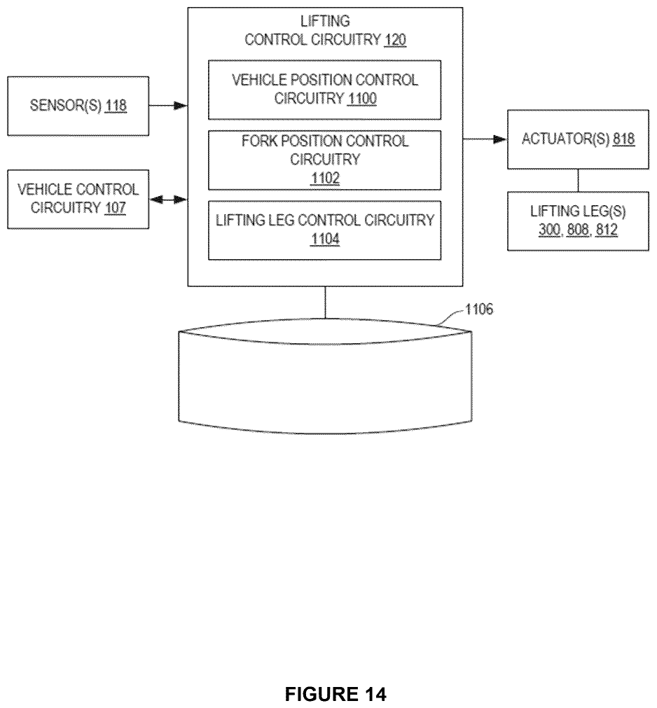

FIG. 14 is a block diagram of an example implementation of the lifting control circuitry 120 of FIGS. 1A-1B to control loading or unloading of the platform 116 relative to the platform loading area 106 of the robotic vehicle 100 of FIGS. 1A-6. The lifting control circuitry 120 of FIG. 14 may be instantiated (e.g., creating an instance of, bring into being for any length of time, materialize, implement, etc.) by programmable circuitry such as a Central Processor Unit (CPU) executing first instructions. Additionally or alternatively, the lifting control circuitry 120 of FIG. 14 may be instantiated by an Application Specific Integrated Circuit (ASIC) and/or (ii) a Field Programmable Gate Array (FPGA) structured and/or configured in response to execution of second instructions to perform operations corresponding to the first instructions, or other equivalent arrangements. It should be understood that some or all of the circuitry of FIG. 14 may, thus, be instantiated at the same or different times. Some or all of the circuitry of FIG. 14 may be instantiated, for example, in one or more threads executing concurrently on hardware and/or in series on hardware. Moreover, in some examples, some or all of the circuitry of FIG. 14 may be implemented by microprocessor circuitry executing instructions and/or FPGA circuitry performing operations to implement one or more virtual machines and/or containers.

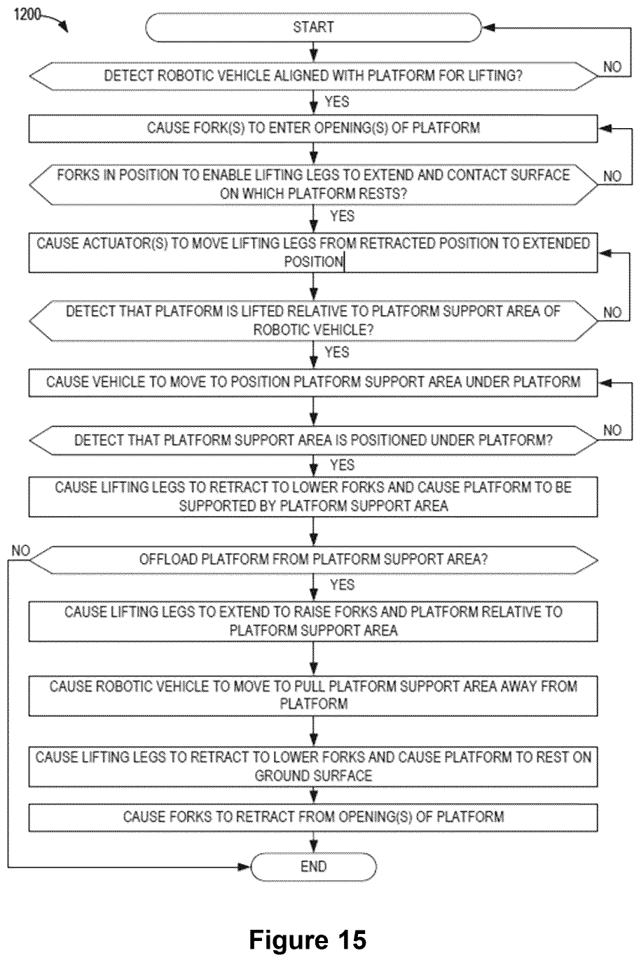

The example lifting control circuitry 120 of FIG. 14 includes vehicle position control circuitry 1100, fork position control circuitry 1102, and lifting leg control circuitry 1104. In some examples, the vehicle position control circuitry 1100 is instantiated by programmable circuitry executing vehicle position control instructions and/or configured to perform operations such as those represented by the flowchart of FIG. 15. In some examples, the fork position control circuitry 1102 is instantiated by programmable circuitry executing fork position control instructions and/or configured to perform operations such as those represented by the flowchart of FIG. 15. In some examples, the lifting leg control circuitry 1104 is instantiated by programmable circuitry executing lifting leg control instructions and/or configured to perform operations such as those represented by the flowchart of FIG. 12.

The example vehicle position control circuitry 1100 analyzes the output(s) of the sensor(s) 118 to determine if the body 102 of the robotic vehicle 100 is positioned relative to a platform 116 such that if the forks 112, 114, 802 of the lifting shuttle 108 were extended, the forks 112, 114, 802 would enter opening(s) 122 of the platform 116. For example, the vehicle position control circuitry 1100 can analyze image data or proximity data represented by the outputs of the sensor(s) 118 to detect the position of the vehicle 100 relative to the platform 116 based on sensor data analysis rule(s) stored in a database 1106. In some examples, the lifting control circuitry 120 includes the database 1106; in other examples the database 1106 is in a location accessible by the lifting control circuitry 120. In some examples, the vehicle position control circuitry 1100 communicates with the vehicle control circuitry 107 to identify the position of the vehicle 100.

When the vehicle position control circuitry 1100 determines that the vehicle 100 is in a position to dock with the platform 116, the example fork position control circuitry 1102 instructs the lifting shuttle 108 to move (e.g., via actuators carried by the vehicle 100) from a stored position to a protruded position to cause the forks 112, 114, 802 to protrude from the vehicle body 102 and enter the opening(s) of the platform 116. In some examples, the fork position control circuitry 1102 automatically causes the forks 112, 114, 802 to protrude based on feedback from the vehicle position control circuitry 1100. In some examples, the fork position control circuitry 1102 additionally or alternatively identifies if a user input has been received at the vehicle 100 indicating that the forks 112, 114, 802 should protrude.

The lifting leg control circuitry 1104 analyzes the outputs of the sensor(s) 118 to determine if the forks 112, 114, 802 are positioned relative to the platform 116 such that lifting legs 300, 808, 812 can be extended and contact the surface 400 on which the platform 116 rests (rather than contacting the platform 116). In some examples, the fork position control circuitry 1102 instructs the forks 112, 114, 802 to retract and re-enter the opening(s) 122 of the platform 116 to facilitate alignment of the forks 112, 114, 802 with the platform 116 to enable the lifting legs 300, 808, 812 to lower to engage the surface 400 and not the platform 116.

If the lifting leg control circuitry 1104 determines that the lifting legs 300, 808, 812 should be extended (e.g., based on rule(s) stored in the database 1106), the lifting leg control circuitry 1104 generates instructions to cause the actuator(s) 818 of the lifting shuttle 108 to move the lifting legs 300, 808, 812 to the extended position. The extension of the lifting legs 300, 808, 812 pushes the forks 112, 114, 802 and the platform 116 upward relative to the surface 400.

The fork position control circuitry 1102 determines, based on the outputs of the sensor(s) 118 and rule(s) stored in the database 1106, when the forks 112, 114 and, thus, the platform 116, are in a position such that the platform 116 is raised above the platform support area 106 of the vehicle 100 with sufficient clearance as a result of the extension of the lifting legs 300, 808, 812. When the platform 116 is identified as being above the platform support area 106, the vehicle position control circuitry 1100 instructs the vehicle 100 to move toward the protruded lifting shuttle 108 and the platform 116 to position the platform support area 106 under the platform 116. In some examples, the vehicle position control circuitry 1100 communicates with the vehicle control circuitry 107 to cause the vehicle 100 to move.

The vehicle position control circuitry 1100 determines, based on the outputs of the sensor(s) 118 and rule(s) stored in the database 1106, that the platform support area 106 is in a loading position to receive the platform 116. In response, the lifting leg control circuitry 1104 instructs the actuator(s) 818 to cause the lifting legs 300, 808, 812 to retract. The retraction of the lifting legs 300, 808, 812 causes the forks 112, 114, 802 to lower and the platform 116 to be supported on the platform support area 106 of the vehicle 100.

While an example manner of implementing the lifting control circuitry 120 of FIGS. 1A-1B is illustrated in FIG. 14, one or more of the elements, processes, and/or devices illustrated in FIG. 14 may be combined, divided, re-arranged, omitted, eliminated, and/or implemented in any other way. Further, the example vehicle position control circuitry 1100, the example fork position control circuitry 1102, the example lifting leg control circuitry 1104 and/or, more generally, the example the lifting control circuitry 120 of FIG. 11, may be implemented by hardware alone or by hardware in combination with software and/or firmware. Thus, for example, any of the example vehicle position control circuitry 1100, the example fork position control circuitry 1102, the example lifting leg control circuitry 1104, and/or, more generally, the example the lifting control circuitry 120, could be implemented by programmable circuitry in combination with machine readable instructions (e.g., firmware or software), or equivalents. Further still, the example the lifting control circuitry 120 of FIG. 11 may include one or more elements, processes, and/or devices in addition to, or instead of, those illustrated in FIG. 11, and/or may include more than one of any or all of the illustrated elements, processes, and devices.

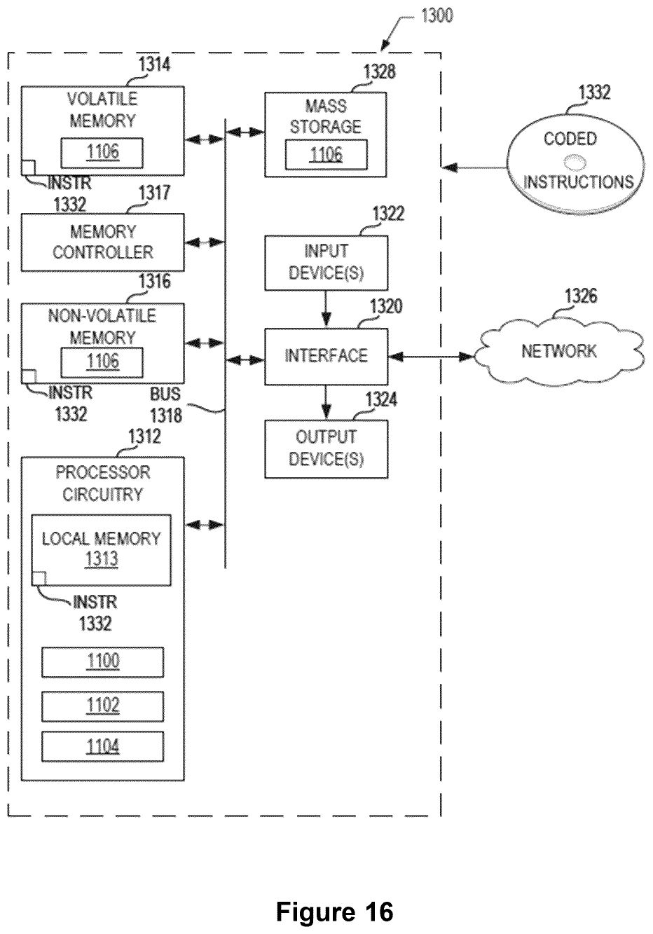

A flowchart representative of example machine readable instructions, which may be executed by programmable circuitry to implement and/or instantiate the lifting control circuitry 120 of FIG. 14 and/or representative of example operations which may be performed by programmable circuitry to implement and/or instantiate the lifting control circuitry 120 of FIG. 14, is shown in FIG. 15. The machine-readable instructions may be one or more executable programs or portion(s) of one or more executable programs for execution by programmable circuitry such as the programmable circuitry 1312 shown in the example processor platform 1300 discussed below in connection with FIG. 16 and/or may be one or more function(s) or portion(s) of functions to be performed by the example programmable circuitry (e.g., an FPGA). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk, etc. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway. Similarly, the non-transitory computer readable storage medium may include one or more mediums. Further, although the example program is described with reference to the flowchart illustrated in FIG. 12, many other methods of implementing the example the lifting control circuitry 120 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As mentioned above, the example operations of FIG. 12 may be implemented using executable instructions (e.g., computer readable and/or machine-readable instructions) stored on one or more non-transitory computer readable and/or machine-readable media.

FIG. 15 is a flowchart representative of example machine readable instructions and/or example operations 1200 that may be executed, instantiated, and/or performed by programmable circuitry to load or unload a platform relative to a robotic vehicle.

FIG. 16 is a block diagram of an example programmable circuitry platform 1300 structured to execute and/or instantiate the example machine-readable instructions and/or the example operations of FIG. 12 to implement the lifting control circuitry 120 of FIG. 14. The programmable circuitry platform 1300 can be, for example, a server, a personal computer, a workstation, a self-learning machine (e.g., a neural network), a mobile device (e.g. a smart phone) or any other type of computing and/or electronic device.

The programmable circuitry platform 1300 of the illustrated example includes programmable circuitry 1312. The programmable circuitry 1312 of the illustrated example may be hardware. In this example, the programmable circuitry 1312 implements the example vehicle position control circuitry 1100, the example fork position control circuitry 1102, and the example lifting leg control circuitry 1104.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, etc.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices, for example an LED display. The interface circuitry 1320 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1332, which may be implemented by the machine-readable instructions of FIG. 12, may be stored in the mass storage device 1328, in the volatile memory 1314, in the non-volatile memory 1316, and/or on at least one non-transitory computer readable storage medium such as a CD or DVD which may be removable.

The invention may also be described with reference to the following numbered clauses:

Clause 1.—A robotic vehicle comprising: a body defining a platform support area; a lift shuttle moveable relative to the body, the lift shuttle including a first fork and a second fork; the robotic vehicle being configured, in use, to: move the lift shuttle from a first position to a second position relative to the body to cause the first fork and the second fork to protrude relative to the body; move the first fork and the second fork to lift a platform; and move the platform toward the body of the robotic vehicle wherein when the first fork and the second fork are retracted to position the platform support area under the platform.

Clause 2.—The robotic vehicle of clause 1, wherein the first fork comprises a first leg, a second leg and an actuator associated with the first fork, and the second leg comprises a first leg, a second leg and an actuator associated with second fork the robotic vehicle being configured, in use, to move the first legs and the second legs from a respective retracted position to a respective extended position to lift the platform.

Clause 3.—The robotic vehicle of clause 2, wherein each actuator is operatively coupled to the respective first leg and second leg via a connector.

Clause 4.—The robotic vehicle of clause 2 or clause 3, the robotic vehicle being configured, in use, to move the first leg and the second leg from the extended position to the retracted position when the platform support area is positioned under the platform.

Clause 5. The robotic vehicle of clause 4, the robotic vehicle being configured, in use, to: move the first leg and the second leg from the retracted position to the extended position when the platform support area is positioned under the platform and the lift shuttle is in the first position; move the platform support area away from the platform; move the first leg and the second leg from the extended position to the retracted position when the platform support area is moved away from the platform; and disengage the first fork and the second fork from the platform.

Clause 6.—The robotic vehicle of any preceding clause, further including an image sensor, the robotic vehicle being configured, in use, to: determine a position of the body relative to the platform based on outputs of the image sensor; and cause the lift shuttle to move from a first position to a second position responsive to the determination of the position of the body.

Clause 7.—The robotic vehicle of any preceding clause, wherein the first fork and the second fork are received in openings defined in the platform support area when the lift shuttle is in the first position.

Clause 8.—The robotic vehicle of any preceding clause, wherein the body defines a housing and at least a portion of the lift shuttle is received in a housing of the body when the lift shuttle is in the first position.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A robotic vehicle comprising:
a body, the body including a platform support area;
a drive means configured, in use, to move the robotic vehicle on a surface, the drive means including one or more rotatable means to support the robotic vehicle on the surface;
a lifting shuttle including an actuator, a first fork and a second fork;
the first fork including a first lifting leg received near a first end of the first fork and a second lifting leg received near a second end of the first fork;
the second fork including a first lifting leg received near a first end of the second fork and a second lifting leg received near a second end of the second fork;
the first and second forks being received within the body such that the first and second forks are held above the surface;
the actuator being coupled to the lifting legs;
wherein in use the robotic vehicle is configured to;
extend the second end of the first and second forks to protrude from the body of the robotic vehicle;
insert at least a portion of the first and second forks into an interior of a platform;
activate the actuator to cause the first and second lifting legs of the first and second forks to extend to contact the surface and lift the platform;
move relative to the platform such that the platform is received above the platform support area; and
retract the first and second lifting legs of the first and second forks such that the platform is received on the platform support area.

2. The robotic vehicle of claim 1, wherein the actuator is directly connected to the first lifting legs of the first fork and the second fork.

3. The robotic vehicle of claim 1, wherein the robotic vehicle includes a first actuator and a second actuator, the first actuator being directly connected to the first lifting leg of the first fork and the second actuator being directly connected to the first lifting leg of the second fork.

4. The robotic vehicle of claim 1, wherein each first lifting leg is connected to the respective second lifting leg by a connector received within the respective fork.

5. The robotic vehicle of claim 1, wherein the first and second lifting legs are received in a retracted position within their respective fork.

6. The robotic vehicle of claim 1, wherein the actuation of the actuator causes the first and second lifting legs to rotate from their retracted position such that they contact the surface and lift the platform.

7. The robotic vehicle of claim 1, wherein the lifting shuttle includes an actuator support.

8. The robotic vehicle of claim 7, wherein the first end of the first fork and the first end of the second fork are supported by the actuator support.

9. The robotic vehicle of claim 1, wherein movement of the lifting shuttle causes the second end of the first and second forks to protrude from the body of the robotic vehicle.

10. The robotic vehicle of claim 9, wherein the lifting shuttle moves from a first position within the body of the robotic vehicle to a second position which is partially or entirely outside of the body of the robotic vehicle.

11. A method of lifting a platform from a surface using a robotic vehicle the method comprising:
advancing a first fork and a second fork from the robotic vehicle into an interior of the platform, the first fork including a first lifting leg and second lifting leg and the second fork including a first lifting leg and a second lifting leg, wherein the robotic vehicle supports the first fork and the second fork above the surface;
applying a force to the first lifting leg and the second lifting leg of the first and second forks such that the first lifting leg and the second lifting leg of the first and second forks contact the surface;
applying a force to the first lifting leg and the second lifting leg of the first and second forks such that the platform is lifted from the surface;
moving the platform so it is received above a support area of the robotic vehicle; and
moving the platform so it is received on the support area of the robotic vehicle.

12. The method of claim 11, wherein the platform is moved such that it is received on the support area of the robotic vehicle by advancing the robotic vehicle towards the platform and lowering the platform onto the support area of the robotic vehicle.

13. The method of claim 12, wherein the platform is lowered onto the support area of the robotic vehicle by reducing the force that is applied to the first lifting leg and the second lifting leg of the first and second forks.

14. A non-transitory computer-readable medium comprising machine-readable instructions to cause at least one processor circuit of a robotic vehicle to:
advance a first fork and a second fork from the robotic vehicle into an interior of a platform, the first fork including a first lifting leg and second lifting leg and the second fork including a first lifting leg and a second lifting leg, wherein the robotic vehicle supports the first fork and the second fork above a surface;
apply a force to the first lifting leg and the second lifting leg of the first and second forks such that the first lifting leg and the second lifting leg of the first and second forks contact the surface;
apply a force to the first lifting leg and the second lifting leg of the first and second forks such that the platform is lifted from the surface;
move the platform so it is received above a support area of the robotic vehicle; and
move the platform so it is received on the support area of the robotic vehicle.

15. The non-transitory computer-readable medium according to claim 14, wherein the machine-readable instructions are to cause one or more of the least one processor circuit to move the platform such that the platform is received on the support area of the robotic vehicle by advancing the robotic vehicle towards the platform and lowering the platform onto the support area of the robotic vehicle.

16. The non-transitory computer-readable medium according to claim 15, wherein the machine-readable instructions are to cause one or more of the least one processor circuit to lower the platform onto the support area of the robotic vehicle by reducing the force that is applied to the first lifting leg and the second lifting leg of the first and second forks.
